(19) United States
(12) Patent Application Publication
(10) Pub. No.: US 2006/0214087 A1
(43) Pub. Date: Sep. 28, 2006

(54) Imaging device and method, and imaging controlling apparatus and method

(76) Inventors: Hideaki Komori, Kanagawa (JP); Akihiko Nose, Kanagawa (JP)

Correspondence Address: FROMMER LAWRENCE & HAUG LLP, 745 FIFTH AVENUE, NEW YORK, NY, 10151, US

(21) Appl. No.: 11/386,287

(22) Filed: Mar. 22, 2006

(30) Foreign Application Priority Data
Mar. 25, 2005 (JP) P2005-089496

(51) Int. Cl. H01L 27/00

(52) U.S. Cl. 250/208.1

(57) ABSTRACT

Captured images free of noise are acquired with an arbitrary shutter speed. There is provided an imaging device that includes a solid-state image sensing device including a light-receiving unit in which there is disposed a plurality of light-receiving elements, vertical transfer units, and a horizontal transfer unit, the solid-state image sensing device being adapted such that the charge stored in each of the plurality of light-receiving elements is read to the vertical transfer units, the charges read to the vertical transfer units are vertically transferred at a first transfer rate for a high-rate transfer period, and the charge in each of the vertical transfer units is vertically transferred at a second transfer rate slower than the first transfer rate for a normal-rate transfer period following the high-rate transfer period, to thereby output the charges supplied to the horizontal transfer unit for the normal-rate transfer period as valid ones from the horizontal transfer unit, a memory to provisionally save image outputs read from the solid-state image sensing device, and a timing generator to control the operations of the solid-state image sensing device and memory, the timing generator providing such a control that when generating a charge sweep-away signal for an effective video period other than horizontal blanking, the solid-state image sensing device stops the horizontal-transfer operation during generation of the charge sweep-away signal to continuously read image outputs via the memory.

### CROSS REFERENCES TO RELATED APPLICATIONS

The present invention contains subject matter related to Japanese Patent Application JP 2005-089496 filed in the Japanese Patent Office on Mar. 25, 2005, the entire content of which is incorporated herein by reference.

### BACKGROUND OF THE INVENTION

1. Field of the Invention

The present invention relates to an imaging device and method, and an imaging controlling apparatus and method, adopted in an imaging system, monitoring system, etc. oriented for the factory automation (FA) to image, for example, an object moving at a high speed.

2. Description of the Related Art

In the imaging devices for FA and monitoring, rapid acquisition of only video information has been attained in the past by transferring an unnecessary signal at a high rate to sweep them away while transferring a necessary signal at a normal rate for processing them as valid pixels. This is called “high-rate function”, for example. To have the imaging device as a camera with the high-rate function, it is necessary to enter a reference signal indicative of a start point of a rapid-transfer period and also a control signal indicating that the imaging device is operating in the rapid-transfer period.

The Applicant of the present invention proposed an image sensing device driving controlling method, imaging device, imaging controlling apparatus and imaging system, in which valid charges falling within a predetermined imaging range can be acquired as video signals by capturing images with a high-speed random shutter synchronized with a trigger signal by controlling the effective charge storage time of a solid-state image sensing device (CCD image sensor) of an interline transfer (IT) type (see the Japanese Patent Application Laid Open No. 191177 of 1998, for example).

In the imaging system, an image charge stored in each of a plurality of light-receiving elements in the IT type solid-state image sensing device is read to vertical transfer units in response to a charge read signal of a predetermined timing based on the trigger signal, the image charges read to the vertical transfer units are vertically transferred at a high rate synchronously with a vertical sync pulse and then read as image signal from the vertical transfer units via a horizontal transfer unit at a normal transfer rate synchronous with a horizontal sync signal. In this imaging system, valid charges falling within an arbitrary imaging range can be acquired as image signals by setting a rapid-transfer period to change the number of lines outputted as image signals.

The electronic shutter function of the CCD image sensor used in this type of imaging system has been performed in the past by controlling the length of charge storage time by sweeping away a charge stored in each of the light-receiving elements of the CCD image sensor to a substrate.

### SUMMARY OF THE INVENTION

Note that in the imaging system using the CCD image sensor having the electronic shutter function that is performed by controlling the length of charge storage time by sweeping away a charge stored in each of the light-receiving elements to a substrate as above, existence of a charge sweep-away signal SUB in an effective video period causes a noise in an output video signal. On this account, for other than a rapid shuttering in which the charge is to be swept away for a vertical blanking period, it is necessary to sweep away the charge for a horizontal blanking period, the length of charge storage time has to be controlled in units of one horizontal scanning period, and only an approximate middle shutter speed can be set when the shutter speed is controlled to a middle one rather approximate to a high one.

For example, even when the shutter speed should be set to 1/1000 sec like a charge sweep-away pulse SUB′ as shown FIG. 1, it can only be set to 1/1004 sec like a charge sweep-away pulse SUB in practice.

The shutter speed is very important factor for sharply imaging of an object moving at a middle speed. Unless the shutter speed can be fine-adjusted, some objects cannot sharply be imaged as the case may be.

Also, even if it is tried to overcome the above drawback with the conventional technique, no sharp imaging is possible because a noise will occur in an output video signal.

More specifically, in the conventional imaging system, if the shutter speed is forcedly set to 1/1000 sec, a noise will occur in a valid video signal because there exists the charge sweep-away signal SUB while a horizontal blanking signal HBLK is being high as in FIG. 1, that is, for an effective video period.

It is therefore desirable to overcome the above-mentioned drawbacks of the related art by providing an imaging device and method and an imaging controlling apparatus and method, in which captured images can be acquired noiselessly with an arbitrary shutter speed.

According to the present invention, a CCD image sensor is controlled to stop taking valid video signals into a memory when it comes across a video signal incurring a noise and set the stopped part of the valid video signals as invalid not to take the noise-incurring video signal into the memory when the valid video signals are taken into the memory, thereby providing a noise-free, accurately controlled image as a final video output from the memory.

According to the present invention, there is provided an imaging device including a solid-state image sensing device including a light-receiving unit in which there is disposed in the form of a matrix a plurality of light-receiving elements each of which produces and stores a charge corresponding to the amount of light incident thereupon, vertical transfer units to transfer a charge read from each of the light-receiving elements in the light-receiving unit, and a horizontal transfer unit to output the charges transferred via the vertical transfer units, the solid-state image sensing device being adapted such that the charge stored in each of the plurality of light-receiving elements is read to the vertical transfer units synchronously with the timing of an external trigger signal, the charges read to the vertical transfer units are vertically transferred at a first transfer rate in response to a high-rate vertical transfer signal for a high-rate transfer period, and the charges in the vertical transfer units are vertically transferred at a second transfer rate slower than the first transfer rate in response to a normal-rate vertical transfer signal for a normal-rate transfer period following the high-rate transfer period, to thereby output the charges supplied to the horizontal transfer unit for the normal-rate transfer period as valid ones from the horizontal transfer unit, a memory to provisionally save image outputs read from the solid-state image sensing device; and a timing generator to control the operations of the solid-state image sensing device and memory, the timing generator providing such a control that when a charge sweep-away signal is generated for an effective video period other than horizontal blanking, the solid-state image sensing device stops the horizontal-transfer operation during generation of the charge sweep-away signal to continuously read image outputs via the memory.

According to the present invention, there is also provided an imaging method of outputting, via a memory, image outputs read from a solid-state image sensing device including a light-receiving unit in which there is disposed in the form of a matrix a plurality of light-receiving elements each of which produces and stores a charge corresponding to the amount of light incident thereupon, vertical transfer units to transfer a charge read from each of the light-receiving elements in the light-receiving unit, and a horizontal transfer unit to output the charges transferred via the vertical transfer units, the solid-state image sensing device being adapted such that the charge stored in each of the plurality of light-receiving elements is read to the vertical transfer units synchronously with the timing of an external trigger signal, the charges read to the vertical transfer units are vertically transferred at a first transfer rate in response to a high-rate vertical transfer signal for a high-rate transfer period, and the charges in the vertical transfer units are vertically transferred at a second transfer rate slower than the first transfer rate in response to a normal-rate vertical transfer signal for a normal-rate transfer period following the high-rate transfer period, to thereby output the charges supplied to the horizontal transfer unit for the normal-rate transfer period as valid ones from the horizontal transfer unit, the method being such that when generating a charge sweep-away signal for an effective video period other than horizontal blanking, the solid-state image sensing device stops the horizontal-transfer operation stopped during generation of the charge sweep-away signal to continuously read image outputs via the memory.

According to the present invention, there is also provided an imaging controller to control the operations of an imaging device including a solid-state image sensing device including a light-receiving unit in which there is disposed in the form of a matrix a plurality of light-receiving elements each of which produces and stores a charge corresponding to the amount of light incident thereupon, vertical transfer units to transfer a charge read from each of the light-receiving elements in the light-receiving unit, and a horizontal transfer unit to output the charges transferred via the vertical transfer units, the solid-state image sensing device being adapted such that the charge stored in each of the plurality of light-receiving elements is read to the vertical transfer units synchronously with the timing of an external trigger signal, the charges read to the vertical transfer units are vertically transferred at a first transfer rate in response to a high-rate vertical transfer signal for a high-rate transfer period, and the charges in the vertical transfer units are vertically transferred at a second transfer rate slower than the first transfer rate in response to a normal-rate vertical transfer signal for a normal-rate transfer period following the high-rate transfer period, to thereby output the charges supplied to the horizontal transfer unit for the normal-rate transfer period as valid ones from the horizontal transfer unit, and a memory to provisionally save image outputs read from the solid-state image sensing device, the imaging controller including a timing generator which provides such a control that when generating a charge sweep-away signal for an effective video period other than horizontal blanking, the horizontal-transfer operation in the solid-state image sensing device is stopped during generation of the charge sweep-away signal to continuously read image outputs from the solid-state image sensing device via the memory.

According to the present invention, there is also provided an imaging controlling method device for use in an imaging device including a solid-state image sensing device including a light-receiving unit in which there is disposed in the form of a matrix a plurality of light-receiving elements each of which produces and stores a charge corresponding to the amount of light incident thereupon, vertical transfer units to transfer a charge read from each of the light-receiving elements in the light-receiving unit, and a horizontal transfer unit to output the charges transferred via the vertical transfer units, the solid-state image sensing device being adapted such that the charge stored in each of the plurality of light-receiving elements is read to the vertical transfer units synchronously with the timing of an external trigger signal, the charges read to the vertical transfer units are vertically transferred at a first transfer rate in response to a high-rate vertical transfer signal for a high-rate transfer period, and the charges in the vertical transfer units are vertically transferred at a second transfer rate slower than the first transfer rate in response to a normal-rate vertical transfer signal for a normal-rate transfer period following the high-rate transfer period, to thereby output the charges supplied to the horizontal transfer unit for the normal-rate transfer period as valid ones from the horizontal transfer unit, and a memory to provisionally save image outputs read from the solid-state image sensing device, the method being such that when generating a charge sweep-away signal for an effective video period other than horizontal blanking, the solid-state image sensing device stops the horizontal-transfer operation during generation of the charge sweep-away signal to continuously read image outputs via the memory.

With to the present invention being applied to an application using a middle shutter speed rather near a high one, captured images free of noise can be acquired with a more accurate middle shutter speed.

These objects and other objects, features and advantages of the present invention will become more apparent from the following detailed description of the preferred embodiments of the present invention when taken in conjunction with the accompanying drawings.

### BRIEF DESCRIPTION OF THE DRAWINGS

FIG. 1 is a timing diagram of the operations of the conventional imaging device;

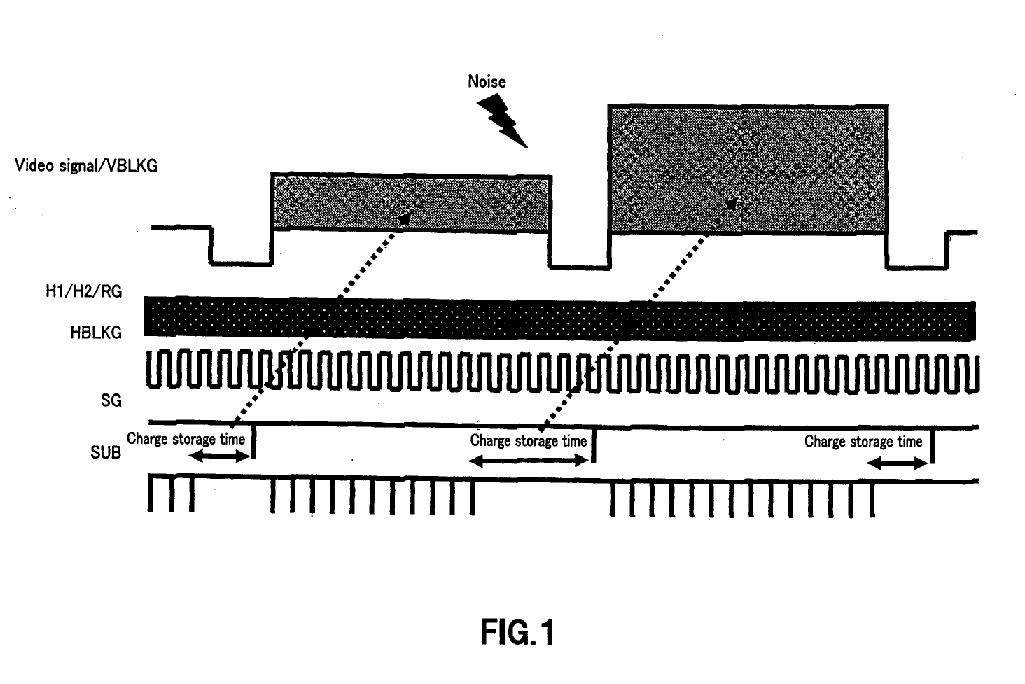

FIG. 2 is a schematic block diagram of the imaging system according to the present invention;

FIG. 3 is also a schematic block diagram of an imaging device included in the imaging system;

FIG. 4 is a schematic plan view of an IT type CCD image sensor included in the imaging device;

FIG. 5 is a schematic block diagram of the substantial part of a timing generator included in the imaging device;

FIG. 6 is a timing diagram of the operations of the timing generator in response to a trigger signal;

FIG. 7 is also a timing diagram of the operations of the timing generator in response to a shutter fine-adjust command; and

FIG. 8 is a timing diagram of the operations of the imaging device.

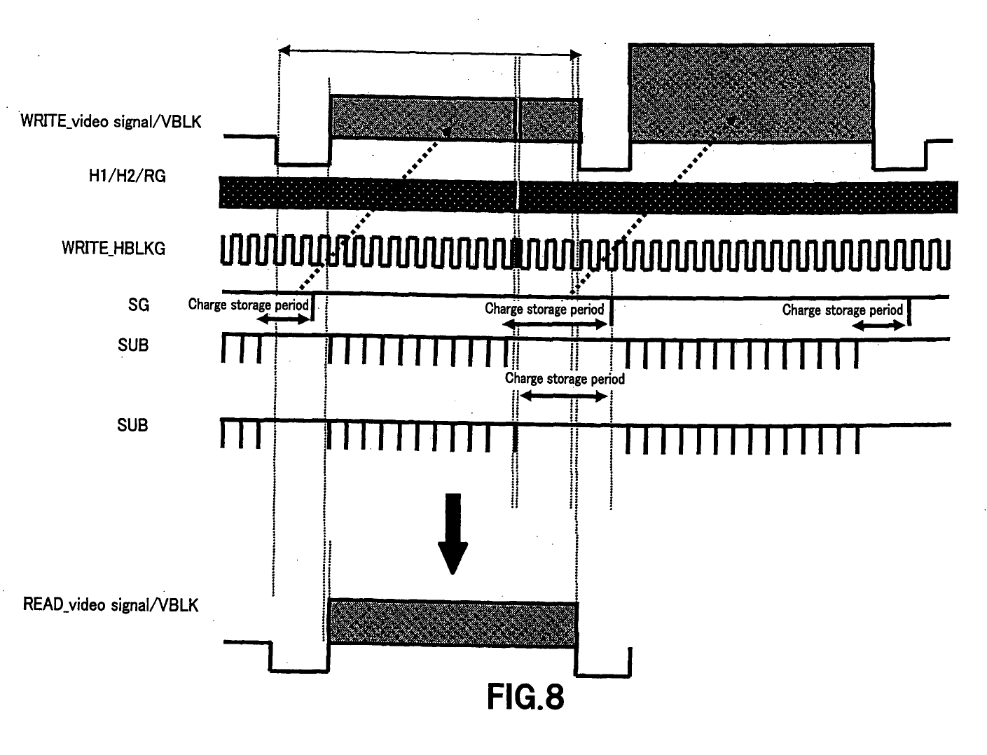

### DETAILED DESCRIPTION OF THE PREFERRED EMBODIMENTS

The present invention will be described in detail below concerning an embodiment thereof with reference to the accompanying drawings.

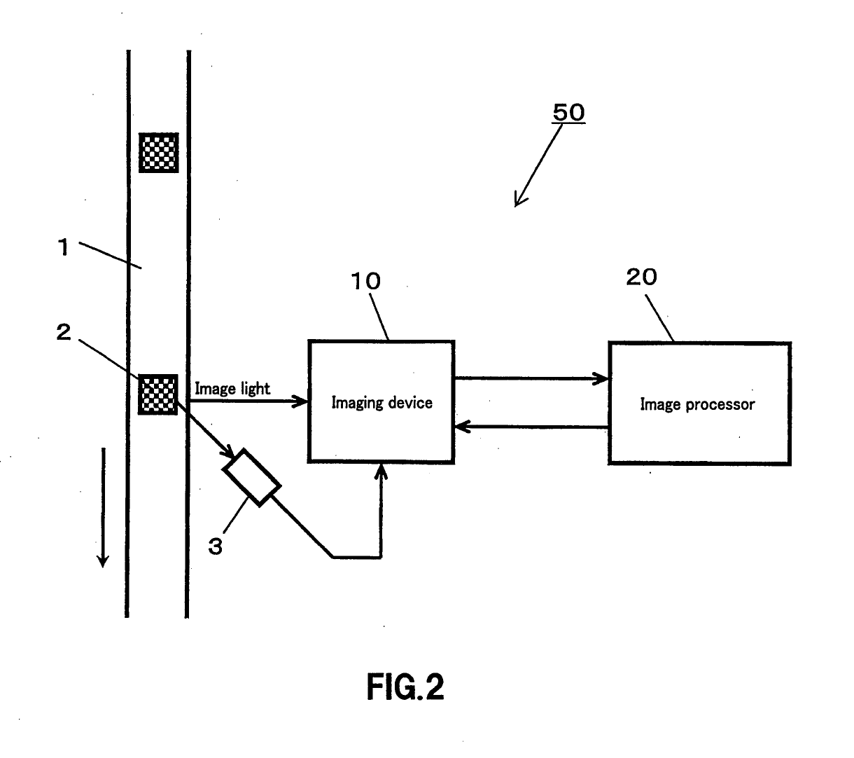

The present invention is applied to an imaging system, generally indicated with a reference numeral 50, constructed as schematically shown in FIG. 2.

In the imaging system 50, an object 2 being carried on a transfer path 1 such as a belt conveyor or the like is detected by an object sensor 3, it is imaged by an imaging device 10 on the basis of a detection output from the object sensor 3, and the captured image is taken in as a still picture. The image data captured by the imaging device 10 by imaging the object 2 on the basis of the detection output from the object sensor 3 is supplied to an image processor 20 also included in the imaging system 50.

In the imaging system 50, the object sensor 3 detects the object 2 being carried on the transfer path 1, a trigger signal TRIG is generated when the object 2 arrives at the front of the object sensor 3, and the trigger signal TRIG is supplied to the imaging device 10.

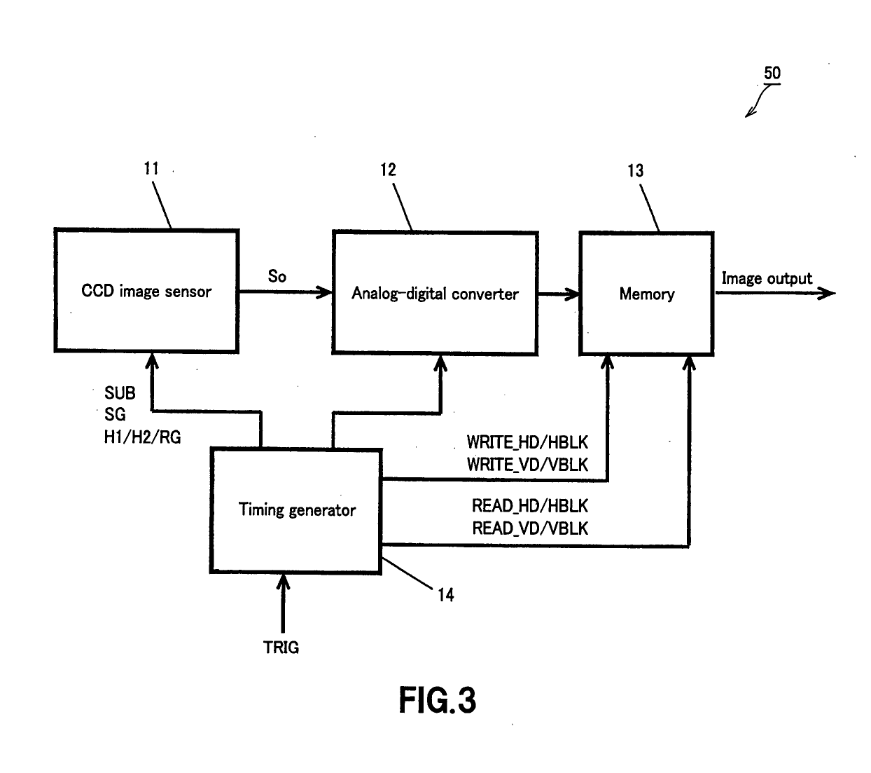

As shown in FIG. 3, the imaging device 10 includes a CCD image sensor 11, analog-digital converter 12 that digitizes an image signal (So) read from the CCD image sensor 11 and outputs it, memory 13 that provisionally saves the image signal (So) digitized by the analog-digital converter 12, and a timing generator 14 that gives an operation clock to each of the above other components of the imaging device 10.

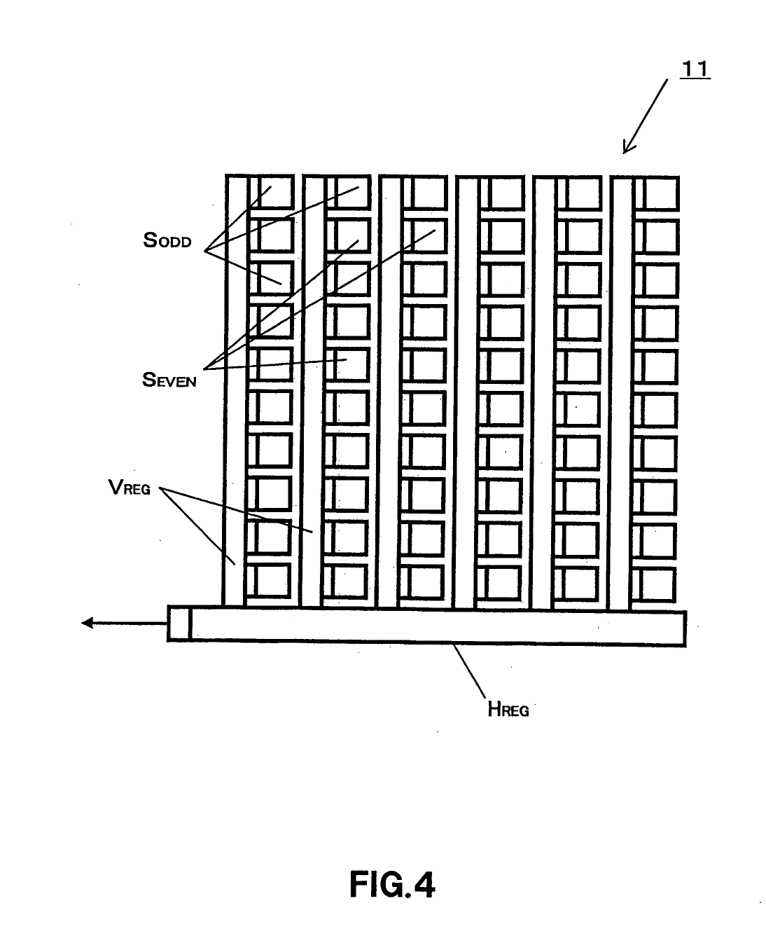

The CCD image sensor 11 is of an interline transfer (IT) type constructed as shown in FIG. 4. It includes light-receiving elements S_{ODD} corresponding to pixels in odd fields and light-receiving elements S_{EVEN} corresponding to pixels in even fields, vertical transfer units V_{REG} to which charges stored in the light-receiving elements S_{ODD} and S_{EVEN} are read, and a horizontal transfer unit H_{REG} that outputs the charges read to the vertical transfer units H_{REG} as image signals in units of one horizontal line. The CDD image sensor 11 performs an electronic shutter function by controlling the potential on a substrate (not shown) formed under the light-receiving elements S_{ODD} and S_{EVEN} to sweep away the charges stored in the light-receiving elements S_{ODD} and S_{EVEN} to the substrate in order to control the length of charge storage time.

The CCD image sensor 11 is driven the timing generator 13 to read the charges stored in the plurality of light-receiving elements S_{ODD} and S_{EVEN} to the vertical transfer units V_{REG} synchronously with the external trigger signal TRIG, transfer the charges read to the vertical transfer units V_{REG} vertically at a first rate in response to a high-rate vertical transfer signal for the high-rate transfer period and transfer the charges in the vertical transfer units V_{REG} vertically at a second rate slower than the first rate in response to a normal-rate vertical transfer signal for a normal-rate transfer period following the high-rate transfer period, to thereby output the charges supplied to the horizontal transfer unit H_{REG} for the normal-rate transfer period as valid ones from the horizontal transfer unit H_{REG}.

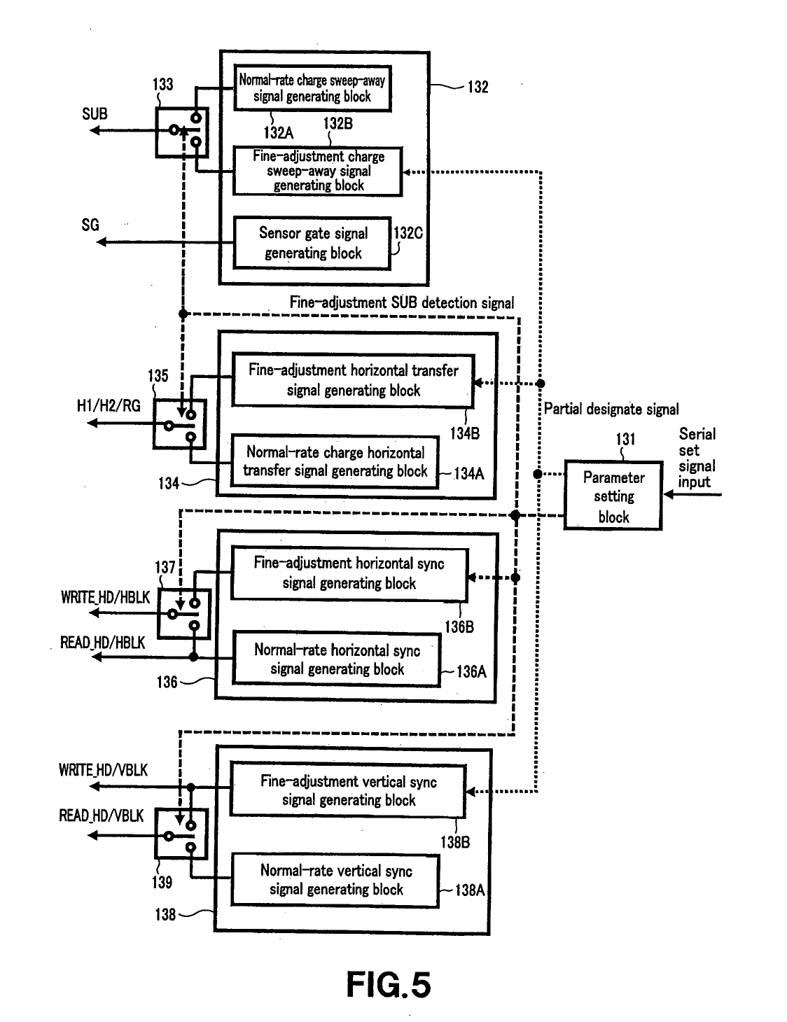

The timing generator 13 in the imaging device 10 has the substantial part thereof illustrated in FIG. 5. As shown, it includes a parameter setting block 131 to set parameters via a serial interface such as USB in response to a serial set signal supplied from the image processor 20, electronic shutter control signal generator 132 to generate an electronic shutter control signal corresponding to a parameter set in the parameter setting block, charge sweep-away signal switch 133 to select a path for a charge sweep-away signal output from the electronic shutter control signal generator 132, horizontal transfer signal generator 134 to generate a horizontal transfer signal corresponding to a parameter set in the parameter setting block 131, horizontal transfer signal switch 135 to select a path for a horizontal transfer signal output from the horizontal transfer signal generator 134, horizontal transfer signal generator 136 to generate a horizontal sync signal corresponding to a parameter set in the parameter setting block 131, horizontal sync signal switch 137 to select a path for a horizontal sync signal output from the horizontal transfer signal generator 136, vertical sync signal generator 138 to generate a vertical sync signal corresponding to a parameter set in the parameter setting block 131, vertical sync signal switch 139 to select a path for a vertical sync signal output from the vertical sync signal generator 138, etc.

The electronic shutter control signal generator 132 includes a normal-rate charge sweep-away signal generating block 132A to generate a normal-rate charge sweep-away signal SUB whose unit is a horizontal scanning period, fine-adjustment charge sweep-away signal generating block 132B to generate a fine-adjustment charge sweep-away signal SUB′ precisely corresponding to an arbitrary shutter speed fine-adjusted to an intended shutter speed such as 1/1000 sec or the like, and a sensor gate signal generating block 132C to generate a normal sensor gate signal SG.

Also, the horizontal transfer signal generator 134 includes a normal-rate charge horizontal transfer signal generating block 134A to generate a normal-rate horizontal transfer signal for a normal transfer rate corresponding to the normal-rate charge sweep-away signal SUB, and a fine-adjustment horizontal transfer signal generating block 134B to generate a fine-adjustment horizontal transfer signal corresponding to the fine-adjustment charge sweep-away signal SUB′.

Also, the horizontal sync signal generator 136 includes a normal-rate horizontal sync signal generating block 136A to generate a normal-rate horizontal sync signal and normal-rate horizontal blanking signal for a normal transfer rate corresponding to the normal-rate charge sweep-away signal SUB, and a fine-adjustment horizontal sync signal generating block 136B to generate a fine-adjustment horizontal sync signal and fine-adjustment horizontal blanking signal corresponding to the fine-adjustment charge sweep-away signal SUB′.

Further, the vertical sync signal generator 138 includes a normal-rate vertical sync signal generating block 138A to generate a normal-rate vertical sync signal and normal-rate vertical blanking signal for a normal transfer rate corresponding to the normal-rate charge sweep-away signal SUB, and a fine-adjustment vertical sync signal generating block 138B to generate a fine-adjustment vertical sync signal and fine-adjustment vertical blanking signal corresponding to the fine-adjustment charge sweep-away signal SUB′.

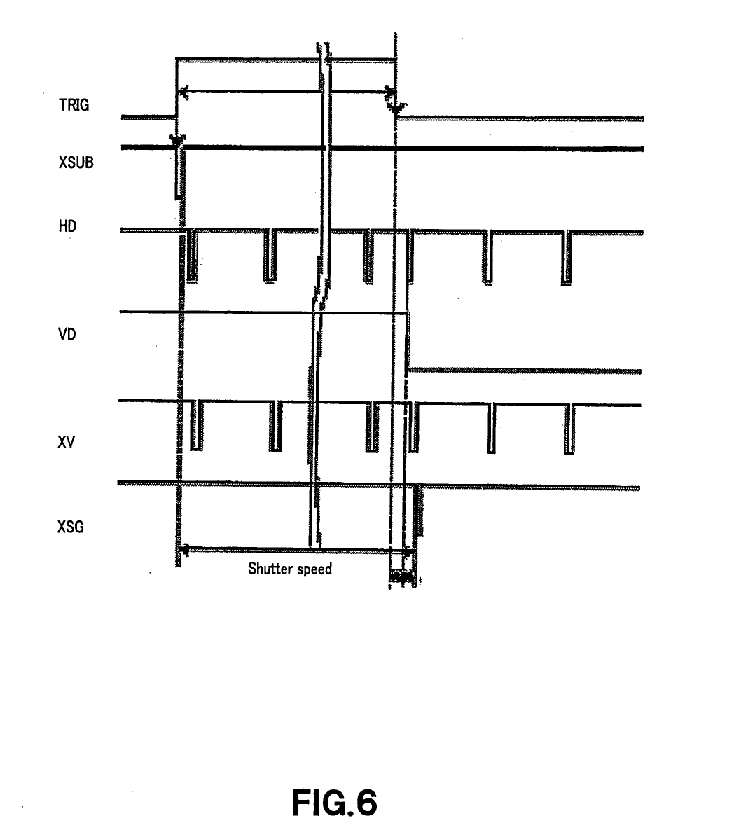

In the timing generator 13, when a trigger signal TRIG is supplied, the horizontal sync signal HD is reset while a vertical sync signal is generated, as shown in FIG. 6. Also, the shutter speed can be controlled in response to a width Wtrig.

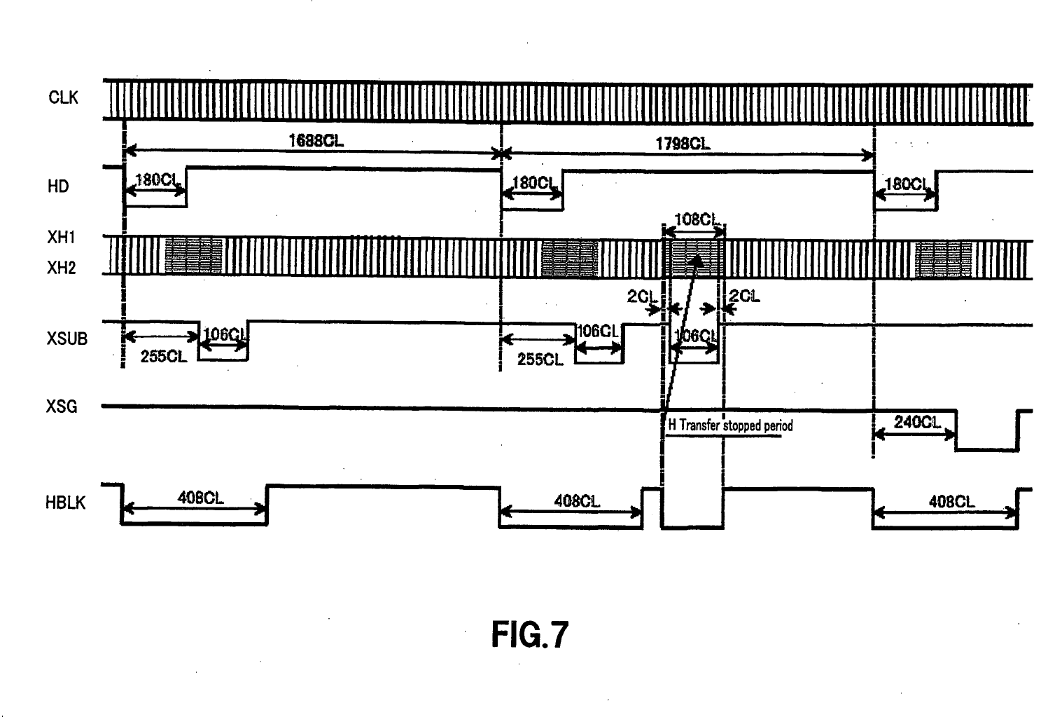

Also, when supplied at the parameter setting block 131 with a shutter fine-adjustment command from the image processor 20 via the serial interface, the timing generator 13 changes the normal-rate charge sweep-away signal SUB whose unit is a signal horizontal scanning period, normal-rate horizontal transfer signal H1/H2/RQ normal-rate horizontal sync signal HD, normal-rate horizontal blanking signal HBLK, normal-rate vertical sync signal VD and normal-rate vertical blanking signal VBLK, generated by the normal-rate charge sweep-away signal generating block 132A, normal-rate horizontal transfer signal generating block 134A, normal-rate horizontal sync signal generating block 136A and normal-rate vertical sync signal generating block 138B, respectively, to the fine-adjustment charge sweep-away signal SUB′, fine-adjustment normal-rate horizontal transfer signal H1′/H2′/RQ fine-adjustment horizontal sync signal HD′, fine-adjustment horizontal blanking signal HBLK′, fine-adjustment vertical sync signal VD′ and fine-adjustment vertical blanking signal VBLK′, generated by the fine-adjustment charge sweep-away signal generating block 132B, fine-adjustment horizontal transfer signal generating block 134B, fine-adjustment horizontal sync signal generating block 136B and fine-adjustment vertical sync signal generating block 138B, respectively. Thus, the horizontal transfer signal H1/H2/RG supplied to the CCD image sensor 10 is stopped for a period for which the fine-adjustment charge sweep-away signal SUB′ occurs to make low the horizontal blanking signal HBLK′ low (an ineffective video period exists), and the effective video period is stopped once, as shown in FIG. 7. When the CCD image sensor 10 is driven, the invalid video part is increased simultaneously and also the period of a sync signal HD′/HBLK′/VD′/VBLK′ is increased.

With the above operations, the fine-adjustment charge sweep-away signal SUB′ is set in the ineffective video period and a video signal free of noise can be acquired with an accurate shutter speed.

With the above operations, the noise problem is solved, but the video signals cannot be acquired in succession. On this account, in the imaging device 10, horizontal transfer signals WRITE_HD/HBLK and READ_HD/HBLK generated by the horizontal transfer signal generator 136 in the timing generator 13 and vertical sync signals WRITE_VD/VBLK and READ_VD/VBLK generated by the vertical sync signal generator 138 are used to save the image signal (So) digitized by the analog-digital converter 12 provisionally in the memory 13, and the video signals are read continuously from the memory 13, as shown in FIG. 7.

It should be understood by those skilled in the art that various modifications, combinations, sub-combinations and alterations may occur depending on design requirements and other factors insofar as they are within the scope the appended claims or the equivalents thereof.

What is claimed is:

1. An imaging device comprising:
a solid-state image sensing device including:
a light-receiving unit in which there is disposed in the form of a matrix a plurality of light-receiving elements each of which produces and stores a charge corresponding to the amount of light incident thereupon;
vertical transfer units to transfer a charge read from each of the light-receiving elements in the light-receiving unit; and
a horizontal transfer unit to output the charges transferred via the vertical transfer units,
the solid-state image sensing device being adapted such that the charge stored in each of the plurality of light-receiving elements is read to the vertical transfer units synchronously with the timing of an external trigger signal, the charges read to the vertical transfer units are vertically transferred at a first transfer rate in response to a high-rate vertical transfer signal for a high-rate transfer period, and the charge in each of the vertical transfer units is vertically transferred at a second transfer rate slower than the first transfer rate in response to a normal-rate vertical transfer signal for a normal-rate transfer period following the high-rate transfer period, to thereby output the charges supplied to the horizontal transfer unit for the normal-rate transfer period as valid ones from the horizontal transfer unit;
a memory to provisionally save image outputs read from the solid-state image sensing device; and
a timing generator to control the operations of the solid-state image sensing device and memory,
the timing generator providing such a control that when generating a charge sweep-away signal for an effective video period other than horizontal blanking, the solid-state image sensing device stops the horizontal-transfer operation during generation of the charge sweep-away signal to continuously read image outputs via the memory.

2. An imaging method of outputting, via a memory, image outputs read from a solid-state image sensing device, the solid-state image sensing device comprising:
a light-receiving unit in which there is disposed in the form of a matrix a plurality of light-receiving elements each of which produces and stores a charge corresponding to the amount of light incident thereupon;
vertical transfer units to transfer a charge read from each of the light-receiving elements in the light-receiving unit; and
a horizontal transfer unit to output the charges transferred via the vertical transfer units,
the solid-state image sensing device being adapted such that the charge stored in each of the plurality of light-receiving elements is read to the vertical transfer units synchronously with the timing of an external trigger signal, the charges read to the vertical transfer units are vertically transferred at a first transfer rate in response to a high-rate vertical transfer signal for a high-rate transfer period, and the charges in the vertical transfer units are vertically transferred at a second transfer rate slower than the first transfer rate in response to a normal-rate vertical transfer signal for a normal-rate transfer period following the high-rate transfer period, to thereby output the charges supplied to the horizontal transfer unit for the normal-rate transfer period as valid ones from the horizontal transfer unit,
the method being such that when generating a charge sweep-away signal for an effective video period other than horizontal blanking, the solid-state image sensing device stops the horizontal-transfer operation during generation of the charge sweep-away signal to continuously read image outputs via the memory.

3. An imaging controller to control the operations of an imaging device, the imaging device comprising:
a solid-state image sensing device including:
a light-receiving unit in which there is disposed in the form of a matrix a plurality of light-receiving elements each of which produces and stores a charge corresponding to the amount of light incident thereupon;
vertical transfer units to transfer a charge read from each of the light-receiving elements in the light-receiving unit; and
a horizontal transfer unit to output the charges transferred via the vertical transfer units,
the solid-state image sensing device being adapted such that the charge stored in each of the plurality of light-receiving elements is read to the vertical transfer units synchronously with the timing of an external trigger signal, the charges read to the vertical transfer units are vertically transferred at a first transfer rate in response to a high-rate vertical transfer signal for a high-rate transfer period, and the charges in the vertical transfer units are vertically transferred at a second transfer rate slower than the first transfer rate in response to a normal-rate vertical transfer signal for a normal-rate transfer period following the high-rate transfer period, to thereby output the charges supplied to the horizontal transfer unit for the normal-rate transfer period as valid ones from the horizontal transfer unit; and
a memory to provisionally save image outputs read from the solid-state image sensing device,
the imaging controller including a timing generator which provides such a control that when generating a charge sweep-away signal for an effective video period other than horizontal blanking, the solid-state image sensing device stops the horizontal-transfer operation during generation of the charge sweep-away signal to continuously read image outputs from the solid-state image sensing device via the memory.

4. An imaging controlling method for use in an imaging device, the imaging device comprising:
a solid-state image sensing device including:
a light-receiving unit in which there is disposed in the form of a matrix a plurality of light-receiving elements each of which produces and stores a charge corresponding to the amount of light incident thereupon;
vertical transfer units to transfer a charge read from each of the light-receiving elements in the light-receiving unit; and
a horizontal transfer unit to output the charges transferred via the vertical transfer units, the solid-state image sensing device being adapted such that the charge stored in each of the plurality of light-receiving elements is read to the vertical transfer units synchronously with the timing of an external trigger signal, the charges read to the vertical transfer units are vertically transferred at a first transfer rate in response to a high-rate vertical transfer signal for a high-rate transfer period, and the charges in the vertical transfer units are vertically transferred at a second transfer rate slower than the first transfer rate in response to a normal-rate vertical transfer signal for a normal-rate transfer period following the high-rate transfer period, to thereby output the charges supplied to the horizontal transfer unit for the normal-rate transfer period as valid ones from the horizontal transfer unit; and
a memory to provisionally save image outputs read from the solid-state image sensing device,
the method being such that when generating a charge sweep-away signal for an effective video period other than horizontal blanking, the solid-state image sensing device stops the horizontal-transfer operation during generation of the charge sweep-away signal to continuously read image outputs via the memory.
